(19) United States
(12) Patent Application Publication
(10) Pub. No.: US 2005/0053819 A1
(43) Pub. Date: Mar. 10, 2005

(54) Solid oxide fuel cell interconnect with catalyst coating

(76) Inventor: Eduardo E. Paz, Collegeville, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/891,500

(22) Filed: Jul. 15, 2004

Related U.S. Application Data
(60) Provisional application No. 60/488,007, filed on Jul. 18, 2003.

(51) Int. Cl. H01M 8/12; H01M 4/92; B05D 5/12

(52) U.S. Cl. 429/32; 429/40; 427/115; 429/44

(57) ABSTRACT

The invention relates to solid oxide fuel cell interconnects that connect two or more fuel cells to one another. The interconnects are coated with a catalyst capable of reforming a hydrocarbon fuel. The catalyst coating assists in reforming hydrocarbons used as a fuel source for the solid oxide fuel cell.

### BACKGROUND OF THE INVENTION

1. Field of the Invention

The invention relates to the use of an internal fuel reforming catalyst coating on an interconnect that connects individual solid oxide fuel cells. The catalyst coating enhances the rate of internal fuel reformation, and improves the thermal efficiency of the fuel cell.

2. Description of Related Art

Fuel cells convert gaseous fuels (such as hydrogen, natural gas, and gasified coal) via an electrochemical process directly into electricity. A fuel cell operates much like a battery, but does not need to be recharged and continuously produces power when supplied with fuel and oxidant, normally air. A typical fuel cell consists of an electrolyte (ionic, H⁺, O²⁻, CO₃²⁻ etc., conductor) in contact with two electrodes (mainly electronic conductors). On connecting the cell to an external load, fuel is oxidized at the anode resulting in the release of electrons that flow through the external load and reduce oxygen at the cathode. The charge flow in the external circuit is balanced by ionic current flows within the electrolyte. Thus, at the cathode, oxygen from the air or other oxidant is dissociated and converted to oxygen ions that migrate through the electrolyte membrane and react with the fuel at the anode/electrolyte interface. The voltage from a single cell under load conditions is in the vicinity of 0.6 to 1.0 V DC and current densities in the range 100 to 500 MAcm⁻² can be achieved.

Several different types of fuel cells are under development for commercial use. Solid oxide fuel cells (SOFC) are regarded as one of the most efficient and versatile power generation systems, as a result of their dispersed power generation, low pollution, good efficiency, high power density and fuel flexibility. In SOFCs, single fuel cells are generally connected via interconnects to form multi-cell units, termed fuel cell stacks. Gas flow paths are provided between the interconnects and single cells' electrodes. Numerous SOFC configurations are under development, including the tubular, the monolithic, and the planar design. The planar or flat plate design is the most widely investigated. In this design, the components—electrolyte/electrode laminates and interconnect plates that may have gas channels formed therein—are fabricated individually and then stacked together and sealed with a high temperature sealing material to form either a fixed or sliding seal. With this arrangement, external and internal co-flow, counter-flow and cross-flow manifolding options are possible for the gaseous fuel and oxidant.

Apart from good electrical, electrochemical, mechanical and thermal properties, the individual cell components must be stable in fuel cells' highly demanding operating environments. SOFCs operate in the vicinity of 950-1000° C., although substantial efforts are under way to reduce the operating temperatures to 800-900° C. Typical life times of 5-6 years of continuous operation are desired for fuel cells to be economical. Thus, long term stability of the various cell components is essential. Only a few materials are likely to fulfill all the requirements. In general, the high operating temperature of SOFCs, the multi-component nature of the fuel cell, and the required life expectancy of several years severely restrict the choice of materials for cells and interconnect components.

The electrolyte of a typical SOFC is made from solid ceramic materials that are efficient ion conductors, typically Y₂O₃-doped ZrO₂, although many other materials have been proposed. A variety of different anode materials have been proposed for use at the fuel side of SOFCs. Generally, the anode is a ceramic-metal composite or cermet, often made from YSZ and nickel. Recent advances in SOFC design have developed anodes containing copper that are capable of directly oxidizing hydrocarbons such as methane and butane, at temperatures lower than the typical SOFC operating temperature discussed above. Likewise, a variety of different cathode materials, generally electroceramics, have been proposed for the airside of SOFCs. Although a wide variety of materials are available to manufacture the components of an SOFC, this invention is independent of the materials used to fabricate the anodes, electrolytes, and cathodes.

The purpose of the interconnect between individual fuel cells, as well as at each end of a fuel cell stack and on every side of a single fuel cell, is to convey electrical current and heat away from the fuel cell or cells. To this extent, an interconnect should have a relatively high electrical conductivity, to minimize voltage losses, with negligible contact resistance at the interconnect/electrode interface. It should also have a relatively high thermal conductivity to provide improved uniformity of heat distribution and to lower thermal stresses. A thermal conductivity above 25 W/m K is desirable. In addition, since an intermediate interconnect in a fuel cell stack extends between the anode of one fuel cell and the cathode of the adjacent fuel cell, the interconnect preferably is impervious to gases in order to avoid mixing of the fuel and the oxidant (see FIG. 1). Thus, the interconnect should have a relatively high density with no open porosity, as well as stability in both oxidizing and reducing environments at the cells' operating temperatures. The interconnect also should have high creep resistance, and a low vapor pressure. The interconnect should further have phase stability during thermal cycling, a low thermal expansion mismatch between cell components, as well as chemical stability with respect to components with which it is in contact. The interconnect also should preferably have reasonable strength, since it may provide structural support, as well as low cost, ease of fabrication and low brittleness.

Known interconnects typically are comprised of ceramic, cermet, and alloy materials. Metallic materials generally have the advantages of high electrical and thermal conductivities and ease of fabrication. The number of available metals that can be used in interconnects, however, is limited because the metals must be stable in the operating environment of SOFC fuel cells (i.e., high temperatures in both reducing and oxidizing atmospheres). Most high temperature oxidation resistant alloys have some type of built-in protection mechanism, usually forming oxidation resistant surface layers as coatings.

Metallic foil interconnects for SOFCs are described in, for example, U.S. Pat. No. 6,106,967, the disclosure of which is incorporated by reference herein in its entirety. The superalloy metallic interconnect is positioned between the anode of one fuel cell and the cathode of another in a stacked array to provide the electrical connection between the individual cells. U.S. Pat. Nos. 5,614,127 and 5,958,304, the disclosures of which are incorporated by reference herein in their entirety, disclose a lanthanum strontium calcium chromite ceramic interconnect material. Other interconnect materials also are known in the art.

It is known in the art that incorporating catalysts into the anode of SOFCs can assist in reforming a hydrocarbon fuel to produce at least hydrogen in an endothermic reaction. The hydrogen is subsequently consumed as the fuel for the cell. The fuel cell reaction produces water and heat and the reforming reaction consumes water and heat, so that in-situ internal reforming can take place within an SOFC in a compatible manner. Such in situ internal reforming is carried out in the fuel cell anode compartment and typically requires that the fuel cell anode be loaded with an appropriate catalyst. U.S. Pat. No. 6,051,329, the disclosure of which is incorporated by reference herein in its entirety, details incorporating a catalyst selected from platinum, rhodium, ruthenium, and mixtures thereof into the anode, as well as other elements. Similar catalyst materials for use in the anode are disclosed in Wang, X., et al., “Steam Reforming of n-Butane on Pd/Ceria”, Catalysis Letters, (2001).

Catalysts also sometimes are incorporated into a current collector placed over the anode compartments of a fuel cell array, as described in U.S. Pat. Nos. 5,660,941 and 6,326,096, the disclosures of each of which are incorporated by reference herein in their entirety. The current collectors tend to be much bulkier than metal foil interconnects, thus making the use of precious metal catalysts prohibitively expensive. As a consequence, preferred catalysts materials for current collectors are the less expensive copper and nickel, which are not the most effective catalyst materials for reforming hydrocarbon fuels.

Anode materials comprised of nickel typically include a catalyst to assist in reforming higher hydrocarbons. The nickel ultimately forms undesirable carbon deposits, however, and significantly decreases the efficiency of the cell. Recent developments to solve this problem with nickel-containing anodes have resulted in the use of copper in an anode, as described in U.S. Pat. No. 6,589,680, the disclosure of which is incorporated by reference herein in its entirety.

The description herein of disadvantages and problems associated with known materials and methods is not intended to limit the invention to materials and methods that do not include some or all of the known materials. Indeed, the invention may include one or more of the known materials or methods without suffering from the aforementioned disadvantages.

### SUMMARY OF THE INVENTION

There exists a need to develop an improved interconnect for use in a SOFC whereby the interconnect assists in reforming hydrocarbon fuels for use by the fuel cells. It therefore is a feature of an embodiment of the invention to enhance the power density of a fuel cell and to increase the ability of the fuel cell to directly utilize higher hydrocarbon fuels. It also is a feature of an embodiment of the invention to provide a SOFC with improved thermal management that uses the steam reforming endothermic reaction to cool sections of the fuel cell for a more uniform overall temperature distribution. These and other features are satisfied by various embodiments of the invention.

In accordance with a feature of the invention, there is provided a solid oxide fuel cell array comprising at least two fuel cells connected to one another by an interconnect, the fuel cells each including an anode, a solid electrolyte, and a cathode. The interconnect connects the anode of one cell with the cathode of another cell, preferably an adjacent cell, and includes a catalyst at least partially capable of reforming a hydrocarbon fuel, where the catalyst is in fluid communication with the hydrocarbon fuel. It is preferred that the catalyst include a base metal and a precious metal selected from rhodium (Rh), ruthenium (Ru), palladium (Pd), and platinum (Pt), although any suitable catalyst material can be used in the invention.

In accordance with an additional feature of an embodiment of the invention, there is provided a method of making a solid oxide fuel cell stack comprising forming at least two fuel cells each including an anode, a solid electrolyte, and a cathode. The method also includes forming an interconnect material including at least one catalyst at least partially capable of reforming a hydrocarbon fuel, and positioning the interconnect between at least two fuel cells such that the catalyst is in fluid communication with the hydrocarbon fuel. The catalyst preferably includes a base metal and a precious metal selected from rhodium (Rh), ruthenium (Ru), palladium (Pd), and platinum (Pt), although any suitable catalyst material may be used in the invention. The method can be completed by placing the plurality of fuel cells into an array, and positioning the interconnects between an anode of one fuel cell and the cathode of another fuel cell.

These and other features of various embodiments of the invention will become more readily apparent to those skilled in the art upon reading the detailed description that follows.

### BRIEF DESCRIPTION OF THE DRAWINGS

FIG. 1 is an illustration of a stacked fuel cell array including two fuel cells separated by an interconnect.

FIG. 2 is an illustration of a portion of an interconnect showing a porous layer and a solid/impermeable layer.

FIG. 3 is an illustration of an interconnect for a single pass fuel flow cell, showing a varied concentration of catalyst throughout the cross-sectional area of the interconnect that is in fluid communication with the fuel.

FIG. 4 is an illustration of three interconnects for a multi-pass fuel flow cell, showing varied concentration of catalyst for each interconnect.

### DETAILED DESCRIPTION OF THE PREFERRED EMBODIMENTS

The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a solid oxide fuel cell” includes a plurality of such fuel cells in a stack, as well as a single cell, and a reference to “an anode” is a reference to one or more anodes and equivalents thereof known to those skilled in the art, and so forth.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods, devices, and materials are now described. All publications mentioned herein are cited for the purpose of describing and disclosing the various anodes, electrolytes, cathodes, and other fuel cell components that are reported in the publications and that might be used in connection with the invention. Nothing herein is to be construed as an admission that the invention is not entitled to antedate such disclosures by virtue of prior invention.

This invention preferably includes an SOFC interconnect plate that contains catalyst materials suitable for steam reforming of hydrocarbon fuels. In some cells, for instance when the anode contains Ni, water is used to suppress carbon formation resulting from the reforming of the fuel. Typical steam to carbon ratios in these systems are in excess of 1.5 to 1 and as high as 3 to 1. In other cells that utilize copper based anodes, such as those described in U.S. Pat. No. 6,589,680, the disclosure of which is incorporated by reference herein in its entirety, hydrocarbons are used directly. In this latter case, water is produced during the electrochemical oxidation of the fuel. This invention takes advantage of the presence of steam in the fuel cell anode (resulting either from water being present in the fuel source and/or from the anode half-cell reaction) to reform the fuel via the catalyst(s) present on the interconnect. The reformation of the fuel is endothermic, which reduces the heat load and is believed to result in higher efficiency of the cell.

For hydrogen fuel, the anode half-cell reaction is
H₂+O²⁻→H₂O+2e⁻

For hydrocarbon and carbon monoxide fuels, respectively, the reactions are
CₓH₂ₓ₊₂+(3x+1)O₂—→xCO₂+(x+1)H₂O+2(3x+1)e⁻
and
2CO+2O²⁻→2CO₂+4e⁻

The steam reforming reaction that likely would take place on the catalytically active surface of the interconnect is as follows:
CₓH_{y}+xH₂O→xCO+(y/2+x)H₂
While not intending on being bound by any theory of operation, the inventor believes that the use of water, a by-product of the anode half-reaction, drives the anode half reaction further to completion and produces a useable fuel, H₂, thereby increasing the efficiency of the fuel cell.

The surface of the interconnect on the anode side can be exposed to the fuel at operating temperatures between 600° C. and 800° C. The surface therefore preferably is coated in order to protect the base metal against corrosion and oxidation, as well as to reduce the electrical contact resistance. Given that these surfaces preferably are coated, adding a catalyst material to this coating is relatively simple and will not add significantly to the manufacturing costs.

The catalyst systems most suitable for internal steam reforming in the present invention application involve the use of a base metal such as Cu or Zn, and a precious metal such as Rh, Ru, Pd, Pt. The catalysts are at least partially capable of reforming a hydrocarbon fuel under the operating conditions of the fuel cell. Preferably, the catalyst are capable of reforming the hydrocarbon fuel under conventional reforming conditions—conditions that may or may not be present during operation of the fuel cell. Additionally, CeO₂ may be used with the precious metal to further improve catalysis. Finally, Al₂O₃ or ZrO₂ may be used as the catalyst support. Other additives may be added to the catalyst composition, as will be appreciated by those skilled in the art.

Typically SOFC anodes employ nickel as both an electronic conductor and a catalyst in the electrochemical oxidation of hydrogen. Further, nickel SOFC cells operating under a favorable carbon to steam ratio can effectively steam reform light hydrocarbon fuels like methane without excessive carbon buildup on the cell. Higher hydrocarbon fuels, however, require reformation prior to contact with the nickel-containing anode since nickel-containing anodes typically are not capable of operating with higher hydrocarbon fuels. Accordingly, the catalyst-containing interconnect of the invention would be suitable for this type of fuel cell, especially with methane fuel.

Other types of SOFC cells may use copper and ceria as active species in the anode. These cells can effectively oxidize higher hydrocarbon fuels directly without excessive carbon buildup. However, both copper and ceria are relatively inert in the presence of methane and do not effectively reform this fuel. The present invention therefore is useful in copper-containing anodes, and especially anodes comprised of at least ceria and copper to provide the requisite fuel reformation. Since the materials identified above as suitable catalysts usually can not be mixed with the copper and ceria in the anode of the fuel cell without creating undesirable alloys, it is beneficial to include the catalyst in the interconnect.

The present invention, therefore, preferably seeks to apply fuel reformation catalysts to a portion of the surface of the interconnect opposite the anode of the fuel cell, or to a portion of the interconnect that is in communication with the fuel provided to the anode. This preferred arrangement of catalyst materials allows for part of the fuel to be directly oxidized by the fuel cell and another part steam reformed by the interconnect catalyst into hydrogen, carbon monoxide and, optionally simpler hydrocarbon molecules that can be more easily oxidized by the anode material. The final selection of catalyst materials, method of application and location on the interconnect surface can be made on the basis of which fuel is to be used, the preferred operating temperature and actual performance of the cell/interconnect system. Using the guidelines provided herein, those skilled in the art are capable of designing a suitable catalyst composition for use with an interconnect depending on the components of the fuel cells, the operating temperatures, and performance of the cell/interconnect system.

This invention is not limited to a particular material for the formation of the interconnect. Particularly preferred materials are those that have a relatively high electrical conductivity, and a relatively high thermal conductivity, e.g., above 25 W/m K, and are substantially impervious to gases. It also is preferred that the interconnect be fabricated in a manner to allow fuel and oxidant to reach the anode of a fuel cell, and to permit exhaust from fuel cell. Suitable fabrication techniques include forming holes or grooves in the interconnect material, or forming a sinusoidal-shaped interconnect.

Suitable interconnects for use in the invention preferably are comprised primarily of ceramic, cermet, and alloy materials. Metallic materials have the advantages generally of high electrical and thermal conductivities and ease of fabrication. The number of available metals that can be used in interconnects, however, is limited because the metals must be stable in the operating environment of SOFC fuel cells (i.e., high temperatures in both reducing and oxidizing atmospheres). Most high temperature oxidation resistant alloys have some type of built-in protection mechanism, usually forming oxidation resistant surface layers as coatings. Metallic materials commonly proposed for high temperature applications include, usually as alloys, Cr, Al, and Si, all of which form oxidation resistant protective layers. For the material to be useful as an interconnect in solid oxide fuel cells, any protective layer that is formed by the material in use should at least be a reasonable electronic conductor. However, oxides of Al and Si are poor conductors. Therefore, the alloys that typically are the most suitable for use as metallic interconnects in SOFCs, whether in cermet or alloy form, contain Cr in varying quantities.

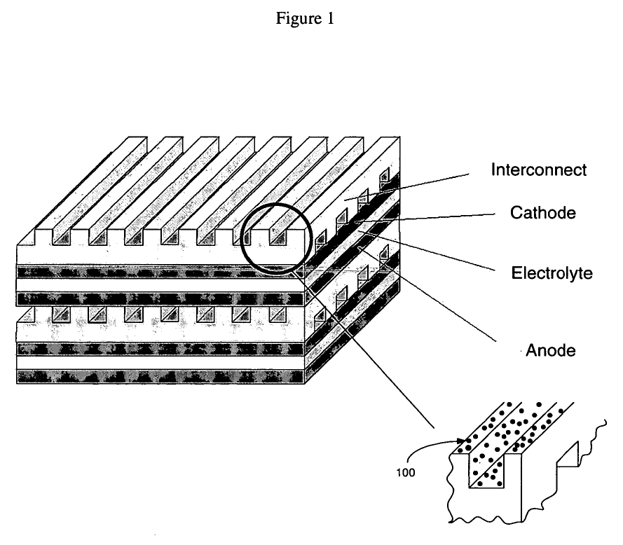

The interconnect useful in the present invention also includes a catalyst capable of reforming a hydrocarbon fuel either by itself, or together with other materials present in the interconnect or at the interconnect/anode interface. The catalyst preferably is coated on the interconnect material after forming the interconnect. FIG. 1 illustrates an interconnect positioned between adjacent fuel cells, whereby a portion of the surface of the interconnect contacting the anode portion of the fuel cell includes a catalyst material 100.

The coating composition can be applied to the interconnect surface by any one of several methods, including painting a slurry carried in an organic or inorganic media; slurry spraying the composition onto a hot or cold substrate; spray pyrolysis onto a hot substrate; flame spraying; solution spraying; flow coating; dipping the interconnect substrate into at least one salt of the catalyst and heating; screen printing; electrolytic deposition, electro-phoretic deposition; physical or chemical evaporation from a target; sputtering (eg RF) of a layer from a target; electrostatic spraying; plasma spraying; laser techniques; deposition of the precious and base metal, for example by electroplating, electroless plating, sputtering (eg DC magnetron), evaporation or slurry coating, followed by oxidation at higher temperatures; and ion beam evaporation. In addition, the catalyst can be impregnated into a partially porous interconnect material using techniques known in the art.

Some of the above methods of applying the coating material are more appropriate than others depending on the composition of the material applied to the substrate, as will be readily recognized by those skilled in the art. Furthermore, other steps or procedures of the method of preparing the interconnect may vary with the particular application method and material. Using the guidelines provided herein, those skilled in the art will be capable of fabricating a suitable interconnect to include a catalyst.

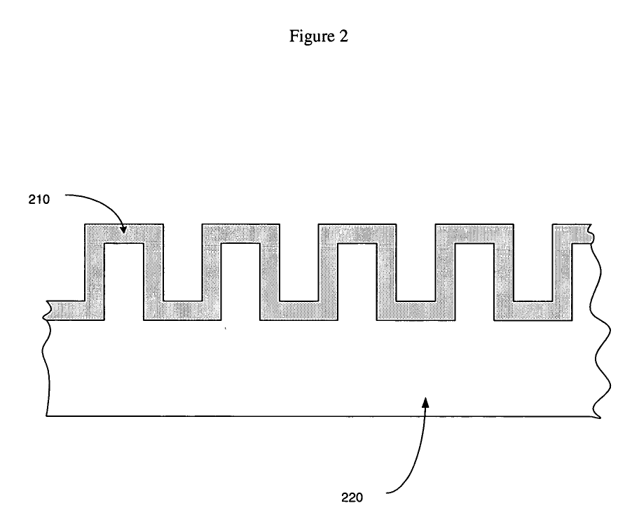

Those skilled in the art will appreciate that methods other than coating can be used in the present invention to prepare an interconnect having a catalyst material on at least one surface thereof, or exposed to at least one surface thereof. For example, a portion of the interconnect can be fabricated of a porous material having catalyst material positioned at least partially within the pores so that the catalyst material may contact the fuel, or otherwise be in fluid communication with the fuel. Such an embodiment is illustrated in FIG. 2, which shows a portion of an interconnect that includes a porous layer 210 that includes a catalyst, and a solid/impermeable layer 220.

Throughout this description, the expression “fluid communication” denotes an arrangement whereby the respective parts are capable of contacting one another during normal operating conditions, whereby the fluid may include gases (i.e., steam, hydrocarbon fuel) or liquids. In this embodiment, the catalyst would not necessarily be coated on the interconnect surface, but rather may be impregnated into the interconnect after preparing the interconnect. Using the guidelines provided herein, skilled artisans will be capable of preparing a suitable interconnect having a catalyst coated or otherwise positioned therein so that the catalyst is available for fuel reformation.

Cleaning the interconnect surface, for example by etching, polishing/grinding etc., prior to application of the coating material, may improve the quality of the coating by improving the adhesion of the catalyst to the surface of the interconnect layer. In addition, it may be beneficial to optionally follow the coating process with a controlled pre-oxidation in a controlled environment, i.e. a controlled oxygen partial pressure to allow the interconnect to develop a chemically resistive surface.

Generally, an SOFC includes a plurality of fuel cells containing an air electrode (cathode), a fuel electrode (anode), and a solid oxide electrolyte positioned between these two electrodes. A typical stacked fuel cell array containing two (2) individual fuel cells is shown in FIG. 1. As shown, the interconnect includes a plurality of grooves or passages positioned generally orthogonal to one another. The grooves adjacent to the anode portion of one fuel cell permit the passage of fuel, while the grooves adjacent to the cathode portion of an adjacent fuel cell permit passage of an oxidant, most preferably air, to the SOFC. The particular configuration of the grooves is not critical to the invention, so long as the interconnect includes passages that permit fuel to reach the anode and provide for an oxidant to reach the cathode of the individual fuel cells.

In a SOFC, the electrolyte is in solid form. Typically, the electrolyte is made of a nonmetallic ceramic, such as dense yttria-stabilized zirconia (YSZ) ceramic. Dense YSZ is a nonconductor of electrons, which ensures that the electrons must pass through the external circuit to do useful work. As such, the electrolyte provides a voltage buildup on opposite sides of the electrolyte, while isolating the fuel and oxidant gases from one another. The anode and cathode are generally porous, with the cathode usually being made of doped lanthanum manganite. In the solid oxide fuel cell, hydrogen or a hydrocarbon is commonly used as the fuel and oxygen or air is used as the oxidant.

The SOFC of the present invention can include any solid electrolyte, any anode, and any cathode made using techniques disclosed in the art. The present invention is not limited to any particular material used for the electrolyte, anode or cathode, nor is it particularly limited to their respective methods of manufacture. Preferably, the anode includes nickel or copper as a conductive metal, and even more preferably, the anode includes ceria and copper.

Any material now known or later discovered can be used as the anode material. A useful anode for use in the SOFC of the invention comprises a porous ceramic material, and an electronically conductive material, preferably positioned at least partially within the pores of the porous ceramic material. The anode materials for use in the present invention preferably are comprised of stabilized YSZ or other electrolyte material impregnated with the electronically conductive material. The electronically conductive material may be in the form of a metal, such as nickel or copper, with copper being preferred, or the electronically conductive material may be a second ceramic material. Preferred second ceramic materials for use in the invention include, but are not limited to ceria, doped ceria such as Gd or Sm-doped ceria, LaCrO₃, SrTiO₃, Y-doped SrTiO₃, Sr-doped LaCrO₃, (LSC) and mixtures thereof. When formulated into the anode together with porous YSZ, the second ceramic material LSC preferably has the formula La_{0.7}Sr_{0.3}CrO_{3-δ}/YSZ. It is understood that the invention is not limited to these particular ceramic materials, and that other ceramic materials may be used in the anode alone or together with the aforementioned ceramic materials. In addition, materials other than stabilized YSZ may be used as the porous ceramic material, including Gc- and Sm-doped ceria (10 to 100 wt %), Sc-doped ZrO₂ (up to 100 wt %), doped LaGaMnOₓ, and other electrolyte materials.

The most common anode materials for solid oxide fuel cells are nickel (Ni)-cermets prepared by high-temperature calcination of NiO and yttria-stabilized zirconia (YSZ) powders. High-temperature calcination is desired in order to obtain the necessary ionic conductivity in the YSZ. These Ni-cermets perform well for hydrogen (H₂) fuels and allow internal steam reforming of hydrocarbons if there is sufficient water in the feed to the anode. Because Ni catalyzes the formation of graphite fibers in dry methane, it is preferred to operate anodes at steam/methane ratios greater than 3. However, there are significant advantages to be gained by operating under dry conditions. Progress in this area has been made using an entirely different type of anode, either based on ceria (See Eguchi, K, et al., Solid State Ionics, 52, 165 (1992); Mogensen, G., Journal of the Electrochemical Society, 141, 2122 (1994); and Putna, E. S., et al., Langmuir, 11 4832 (1995)) or perovskite anodes (See Baker, R. T., et al., Solid State Ionics, 72, 328 (1994); Asano, K., et al., Journal of the Electrochemical Society, 142, 3241 (1995); and Hiei, Y., et al., Solid State Ionics, 86-88, 1267 (1996). Replacement of Ni for other metals, including Co (See Sammes, N. M., et al., Journal of Materials Science, 31, 6060 (1996)), Fe (See Bartholomew, C. H., Catalysis Review-Scientific Engineering, 24, 67 (1982)), Ag or Mn (See Kawada, T., et al., Solid State Ionics, 53-56, 418 (1992)) has been considered; however, with the possible exception of Ag, these are likely to react with hydrocarbons in a way similar to that of Ni. Substitution of Ni with Cu also would be promising but for the fact that CuO melts at the calcination temperatures that typically are used for establishing the YSZ matrix in the anodes. Recent developments, however, have permitted to formation of suitable anode materials containing copper, as well as other lower melting metals. The anode of the invention can include any of the aforementioned materials, or combinations thereof.

Any material now known or later discovered can be used as the cathode material, and as the electrolyte material. Typically, the electrolyte is made of a nonmetallic ceramic, such as dense yttria-stabilized zirconia (YSZ) ceramic, and the cathode is comprised of doped lanthanum manganite. In the solid oxide fuel cell, hydrogen or a hydrocarbon is commonly used as the fuel and oxygen or air is used as the oxidant. Other electrolyte materials useful in the invention include Sc-doped ZrO₂, Gd- and Sm-doped CeO₂, and LaGaMnOx. Cathode materials useful in the invention include composites with Sr-doped LaMnO₃, LaFeO₃, and LaCoO₃, or metals such as Ag.

In a similar manner, the invention is not particularly limited to any design of the SOFC. Several different designs for solid oxide fuel cells have been developed, including, for example, a supported tubular design, a segmented cell-in-series design, a monolithic design, and a flat plate design. All of these designs are documented in the literature, including, for example, those described in Minh, “High-Temperature Fuel Cells Part 2: The Solid Oxide Cell,” Chemtech., 21:120-126 (1991).

The tubular design usually comprises a closed-end porous zirconia tube exteriorly coated with electrode and electrolyte layers. The performance of this design is somewhat limited by the need to diffuse the oxidant through the porous tube. Westinghouse has numerous U.S. patents describing fuel cell elements that have a porous zirconia or lanthanum strontium manganite cathode support tube with a zirconia electrolyte membrane and a lanthanum chromate interconnect traversing the thickness of the zirconia electrolyte. The anode is coated onto the electrolyte to form a working fuel cell tri-layer, containing an electrolyte membrane, on top of an integral porous cathode support or porous cathode, on a porous zirconia support. Segmented designs proposed since the early 1960s (Minh et al., Science and Technology of Ceramic Fuel Cells, Elsevier, p. 255 (1995)), consist of cells arranged in a thin banded structure on a support, or as self-supporting structures as in the bell-and-spigot design.

Planar designs have been described that make use of freestanding electrolyte membranes. A cell typically is formed by applying single electrodes to each side of an electrolyte sheet to provide an electrode-electrolyte-electrode laminate. Typically these single cells then are stacked and connected in series to build voltage. Monolithic designs, which characteristically have a multi-celled or “honeycomb” type of structure, offer the advantages of high cell density and high oxygen conductivity. The cells are defined by combinations of corrugated sheets and flat sheets incorporating the various electrode, conductive interconnect, and electrolyte layers, with typical cell spacings of 1-2 mm for gas delivery channels.

U.S. Pat. No. 5,273,837, the disclosure of which is incorporated herein by reference in its entirety, describes sintered electrolyte compositions in thin sheet form for thermal shock resistant fuel cells. The method for making a compliant electrolyte structure includes pre-sintering a precursor sheet containing powdered ceramic and binder to provide a thin flexible sintered polycrystalline electrolyte sheet. Additional components of the fuel cell circuit are bonded onto that pre-sintered sheet including metal, ceramic, or cermet current conductors bonded directly to the sheet as also described in U.S. Pat. No. 5,089,455, the disclosure of which is incorporated herein by reference in its entirety. U.S. Pat. No. 5,273,837 describes a design where the cathodes and anodes of adjacent sheets of electrolyte face each other and where the cells are not connected with a thick interconnect/separator in the hot zone of the fuel cell manifold. These thin flexible sintered electrolyte-containing devices are superior due to the low ohmic loss through the thin electrolyte as well as to their flexibility and robustness in the sintered state.

Another approach to the construction of an electrochemical cell is disclosed in U.S. Pat. No. 5,190,834 Kendall. The electrode-electrolyte assembly in that patent comprises electrodes disposed on a composite electrolyte membrane formed of parallel striations or stripes of interconnect materials bonded to parallel bands of electrolyte material. Interconnects of lanthanum cobaltate or lanthanum chromite bonded to a yttria stabilized electrolyte are suggested. The SOFC of the present invention may be prepared using any of the techniques described above to provide the desired design, albeit a tubular cell, a monolithic cell, a flat plate cell, and the like. Using the guidelines provided herein, those skilled in the art will be capable of fabricating a SOFC including the inventive anode having any desired design configuration.

A plurality of fuel cells prepared preferably are arranged in an array depending on the ultimate type of SOFC prepared (e.g., tubular, planar, etc.). The method of making the SOFC then includes preparing a catalyst-containing interconnect to connect the anode of one fuel cell to the cathode of another fuel cell, preferably an adjacent fuel cell. The catalyst-containing interconnect preferably is prepared by forming a metallic or ceramic interconnect having the desired shape to effect the interconnection, depending again on the type of SOFC prepared. The metallic or ceramic interconnect can be made from any known metal or ceramic capable of functioning as an interconnect. Suitable materials include, for example, ferritic stainless steel for intermediate and low temperature applications (<800° C.), doped lanthanum chromite for high temperature cells (900 to 1200° C.), or titanium, which has a coefficient of thermal expansion of about 9.3×10⁻⁶ n/m ° C.). This coefficient of thermal expansion matches more closely the coefficient of thermal expansion of the preferred fuel cells in the invention, and consequently, is a preferred interconnect material.

The interconnect then is coated or contacted with the catalytic composition described above. Although any coating technique can be used in the invention, it is preferred to coat the interconnect with the catalytic composition using a vacuum plasma spray technique. Using the guidelines provided herein, those skilled in the art are capable of coating or contacting the interconnect with the catalyst composition of the invention using any known coating technique, including, a vacuum plasma spray technique.

In another embodiment, the interconnect and catalyst materials can be mixed and then formed or suitably processed to form a catalyst-containing interconnect. Alternatively, the interconnect material can be made, and then contacted with a solution, gel, or slurry containing the catalyst material, or salts thereof, such that the catalyst is included within pores in the interconnect. The carrier for the solution, gel, or slurry containing the catalyst material can optionally be removed using techniques known in the art. The catalyst also may suitably coat or adhere to the surface of the interconnect in accordance with this method.

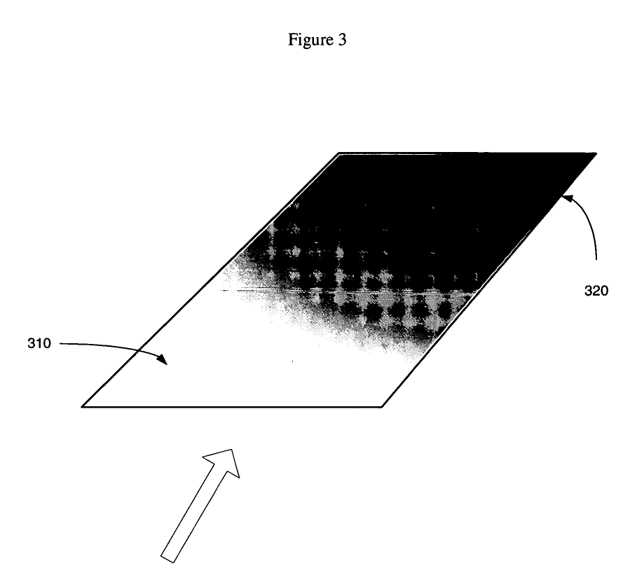

In another embodiment of the invention, the catalytic coating may be applied to only a portion of the interconnect. Many catalysts are costly, and it is preferable to apply them only where they are most effective. For example, it may be desirable in a planar cell to increase the surface density of the catalyst across the interconnect in such a manner that the fresh fuel is exposed to the least amount of catalyst and the reacted fuel is exposed to the greatest amount of catalyst. Such an embodiment is depicted in FIG. 3. FIG. 3 illustrates an increased catalyst concentration along the path of fuel flow in a single pass fuel flow embodiment. In FIG. 3, the fuel flows, as depicted by the arrow, from an area of lower catalyst concentration 310, to an area of higher catalyst concentration 320.

The interconnect then is positioned in the stacked array to provide the desired interconnection between the respective fuel cell units. As shown in FIG. 1, the interconnect can be formed to have a plurality of grooves positioned in such a manner that the grooves permit the passage of fuel to the anode portion of the cells, and additional grooves exhaust material from the cathode portion of the fuel cells.

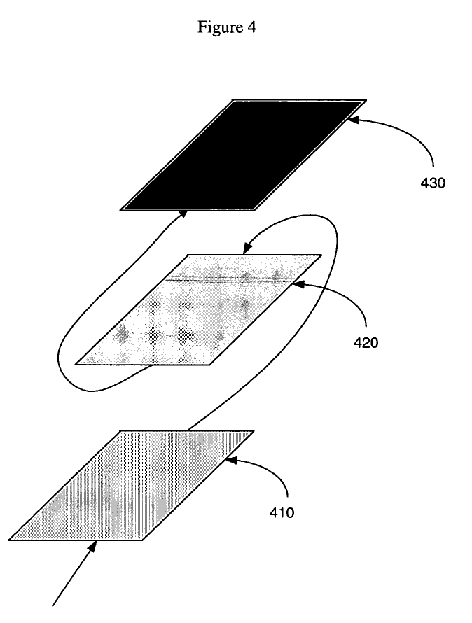

In yet another embodiment, the catalytic coating may vary throughout the fuel cell array, from one interconnect to the other. For example, as shown in FIG. 4, if the fuel is directed from one layer in the SOFC to another layer, the density of the coating could be increased from the first interconnect 410 to the second interconnect 420, and on to a possible third interconnect 430, and so on. The density of the catalyst is increased so that catalytic activity is increased as the fuel becomes depleted and/or the water content in the fuel stream increases. Similarly, different catalysts could be used throughout the fuel cell to optimize the catalytic reforming of the fuel while minimizing the cost of the catalyst.

The interconnect then is positioned in the stacked array to provide the desired interconnection between the respective fuel cell units. As shown in FIG. 1, the interconnect can be formed to have a plurality of grooves positioned in such a manner that the grooves permit the passage of fuel to the anode portion of the cells, and additional grooves exhaust material from the cathode portion of the fuel cells.

The SOFC can be formed in any of a number of ways known in the art. Suitable types of stacked fuel cells are disclosed in, for example, U.S. Pat. Nos. 6,106,967, 6,265,095, 6,228,520, 6,638,658, and 6,653,009, the disclosures of each of which are incorporated by reference in their entirety.

The invention has been described with reference to particularly preferred embodiments. Those skilled in the art recognize that various changes may be made to the invention without departing from the spirit and scope thereof.

1. A solid oxide fuel cell array comprising:
at least two solid oxide fuel cells, each fuel cell comprising an anode, a cathode, and a solid electrolyte positioned at least partially between the anode and the cathode; and
an interconnect positioned at least partially between the at least two solid oxide fuel cells, the interconnect containing at least one catalyst capable of at least partially reforming a hydrocarbon fuel, the catalyst being in fluid communication with the hydrocarbon fuel.

2. The solid oxide fuel cell array as claimed in claim 1, wherein the catalyst comprises a base metal and a precious metal selected from rhodium (Rh), ruthenium (Ru), palladium (Pd), and platinum (Pt).

3. The solid oxide fuel cell array as claimed in claim 2, wherein the base metal is selected from Cu or Zn.

4. The solid oxide fuel cell array as claimed in claim 1, wherein the catalyst further includes at least one component selected from the group consisting of CeO₂, Al₂O₃, ZrO₂, and mixtures or combinations thereof.

5. The solid oxide fuel cell array as claimed in claim 1, wherein the anode comprises copper or nickel.

6. The solid oxide fuel cell array as claimed in claim 5, wherein the anode comprises copper.

7. The solid oxide fuel cell array as claimed in claim 1, wherein the interconnect is comprised of a ceramic metal composite material (cermet) including at least one metal selected from the group consisting of Cr, Al, Si, and mixtures and alloys thereof.

8. The solid oxide fuel cell array as claimed in claim 7, wherein the interconnect is a cermet comprised of at least a ceramic material and Cr.

9. The solid oxide fuel cell array as claimed in claim 1, wherein the catalyst is coated on the surface of the interconnect.

10. The solid oxide fuel cell array as claimed in claim 9, wherein the surface of the interconnect is cleaned prior to coating with the catalyst.

11. The solid oxide fuel cell array as claimed in claim 1, wherein the interconnect is partially porous, and the catalyst is positioned at least partially within the pores of the partially porous portion of the interconnect.

12. The solid oxide fuel cell array as claimed in claim 1, wherein the catalyst concentration in the interconnect varies throughout the cross sectional area of the interconnect that is in fluid communication with the hydrocarbon fuel.

13. The solid oxide fuel cell array as claimed in claim 12, wherein the concentration of catalyst is higher in a portion of the interconnect further downstream from the portion of the interconnect that contacts the hydrocarbon fuel first.

14. The solid oxide fuel cell array as claimed in claim 1, wherein the array contains at least three interconnects and at least two solid oxide fuel cells, each fuel cell being positioned between two interconnects to accommodate multi-pass hydrocarbon fuel flow from one interconnect to another.

15. The solid oxide fuel cell array as claimed in claim 14, wherein the concentration of catalyst in each interconnect varies.

16. The solid oxide fuel cell array as claimed in claim 15, wherein the concentration of catalyst in an interconnect that first contacts the hydrocarbon fuel is lower than the concentration of catalyst in an interconnect that later contacts the hydrocarbon fuel.

17. A method of making a solid oxide fuel cell array comprising at least two solid oxide fuel cells comprising:
preparing at least two solid oxide fuel cells by:
preparing a solid electrolyte;
preparing an anode;
preparing a cathode; and
positioning the solid electrolyte at least partially between the anode and cathode;
preparing an interconnect containing a catalyst at least partially capable of reforming a hydrocarbon fuel; and
positioning the interconnect at least partially between the two solid oxide fuel cells such that the catalyst will be in fluid communication with the fuel during operation of the fuel cell array.

18. The method as claimed in claim 17, wherein the catalyst comprises a base metal and a precious metal selected from rhodium (Rh), ruthenium (Ru), palladium (Pd), and platinum (Pt).

19. The method as claimed in claim 18, wherein the base metal is selected from Cu or Zn.

20. The method as claimed in claim 18, wherein the catalyst further includes at least one component selected from the group consisting of CeO₂, Al₂O₃, ZrO₂, and mixtures or combinations thereof.

21. The method as claimed in claim 17, wherein the anode of at least one fuel cell comprises copper or nickel.

22. The method as claimed in claim 21, wherein the anode comprises copper.

23. The method as claimed in claim 17, wherein preparing the interconnect comprises forming the interconnect from a ceramic metal composite material (cermet) including at least one metal selected from the group consisting of Cr, Al, Si, and mixtures and alloys thereof.

24. The method as claimed in claim 23, wherein the interconnect is a cermet comprised of at least a ceramic material and Cr.

25. The method as claimed in claim 17, wherein preparing the interconnect comprises coating the interconnect with a catalyst.

26. The method as claimed in claim 25, further comprising cleaning the surface of the interconnect prior to coating with the catalyst.

27. The method as claimed in claim 17, wherein preparing the interconnect comprises preparing a partially porous interconnect portion and positioning the catalyst at least partially within the pores of the partially porous interconnect portion.

28. The method as claimed in claim 17, wherein preparing the interconnect comprises varying the catalyst concentration in the interconnect throughout the cross sectional area of the interconnect that is in fluid communication with the hydrocarbon fuel.

29. The method as claimed in claim 28, wherein the concentration of catalyst is higher in a portion of the interconnect further downstream from the portion of the interconnect that contacts the hydrocarbon fuel first.

30. The method as claimed in claim 17, further comprising preparing at least two interconnects and positioning each interconnect on the at least two solid oxide fuel cells such that the array comprises at least three interconnects and at least two solid oxide fuel cells, each fuel cell being positioned between two interconnects to accommodate multi-pass hydrocarbon fuel flow from one interconnect to another.

31. The method as claimed in claim 30, wherein preparing the interconnects comprises preparing each interconnect such that the concentration of catalyst in each interconnect varies.

32. The method as claimed in claim 31, wherein the concentration of catalyst in an interconnect that first contacts the hydrocarbon fuel is lower than the concentration of catalyst in an interconnect that later contacts the hydrocarbon fuel.

33. An interconnect positioned between at least two solid oxide fuel cells comprising:
a cermet interconnect material; and
a catalyst at least partially capable of reforming a hydrocarbon fuel.

34. The interconnect as claimed in claim 33, wherein the catalyst comprises a base metal and a precious metal selected from rhodium (Rh), ruthenium (Ru), palladium (Pd), and platinum (Pt).

35. The interconnect as claimed in claim 34, wherein the base metal is selected from Cu or Zn.

36. The interconnect as claimed in claim 34, wherein the catalyst further includes at least one component selected from the group consisting of CeO₂, Al₂O₃, ZrO₂, and mixtures or combinations thereof.

37. The interconnect as claimed in claim 33, wherein the interconnect is comprised of a ceramic metal composite material (cermet) including at least one metal selected from the group consisting of Cr, Al, Si, and mixtures and alloys thereof.

38. The interconnect as claimed in claim 37, wherein the interconnect is a cermet comprised of at least a ceramic material and Cr.

39. The interconnect as claimed in claim 33, wherein the catalyst is coated on the surface of the interconnect.

40. The interconnect as claimed in claim 39, wherein the surface of the interconnect is cleaned prior to coating with the catalyst.

41. The interconnect as claimed in claim 33, wherein the interconnect is partially porous, and the catalyst is positioned at least partially within the pores of the partially porous portion of the interconnect.

42. The interconnect as claimed in claim 33, wherein the catalyst concentration in the interconnect varies throughout the cross sectional area of the interconnect.
